(19) United States
(12) Patent Application Publication
(10) Pub. No.: US 2010/0028847 A1
(43) Pub. Date: Feb. 4, 2010

(54) SYSTEM AND METHOD OF INTEGRATING LEVELS OF EDUCATIONAL PROGRAMS

(76) Inventor: Linda Proctor Downing, Phoenix, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 12/508,167

(22) Filed: Jul. 23, 2009

Related U.S. Application Data
(63) Continuation-in-part of application No. 11/070,316, filed on Mar. 1, 2005, now abandoned.
(60) Provisional application No. 60/570,906, filed on May 12, 2004.

(51) Int. Cl. G09B 7/00

(52) U.S. Cl. 434/362

(57) ABSTRACT

Adapting to a secondary and post secondary integration process with secondary and post secondary program gives student the opportunity to receive a secondary diploma and earn post secondary credit and/or diploma. The secondary is located in proximity to a post secondary campus or on a uniquely constructed campus in order to share resources and facilities. The student is evaluated to ascertain academic aptitudes and capabilities. The evaluation involves administering a post secondary placement exam prior to scheduling and reviewing prior school transcripts. An administrator of the secondary assigns a class schedule to the student based on the assessment of the student. The class schedule has a combination of secondary classes and post secondary classes. The secondary class is scheduled in accordance with the post secondary class. The student attends the secondary class and post secondary class according to the class schedule. The student earns post secondary credit and/or diploma upon passing the post secondary class. The secondary offers special classes for the student to adapt to the post secondary classes.

### CLAIM TO DOMESTIC PRIORITY

The present application is a continuation-in-part of U.S. patent application Ser. No. 11/070,316, filed on Mar. 1, 2005, titled System and Method of Integrating Levels of Educational Programs, both of which claim priority to provisional application Ser. No. 60/570,906, entitled “Method of Combining Secondary with Post Secondary Education”, filed on May 12, 2004, wherein each of the foregoing are incorporated herein by reference.

### FIELD OF THE INVENTION

The present invention relates in general to educational systems, and more particularly, to a process and method of integrating secondary and post secondary levels of educational programs.

### BACKGROUND OF THE INVENTION

The education system in the United States and most industrialized countries is highly structured and generally inflexible in favor of using a long-established logical process designed to take the student through a myriad of commonly accepted subjects and classes to provide a set of skills in preparation for adult life. In the common progression, the student enters pre-school or grade school and then advances to middle school or junior high school. In most jurisdictions, the grade school through middle school process, i.e., grades 1-8, takes about eight or nine years. The students are exposed to history, geography, sciences, English, mathematics, art, music, as well as other subjects to prepare for the secondary years. In secondary, the students take similar classes at a more advanced level to prepare for post secondary. The students are exposed to the traditional secondary curriculum in grades 9-12, which typically takes four years to complete. In the secondary education process it is possible to complete more the just secondary course work in four years if the process is adapted to a post secondary process and alignment.

From secondary, many students attend post secondary, either by enrolling in a four year university or by attending a community college for two years and then transferring to the four year university. The post secondary setting will have some general coursework required of all students, e.g., English, humanities, economics, and basic math and science. The post secondary student relatively quickly engages in the course work of their selected degree program. By the end of the post secondary program, the student is totally immersed in their chosen academic discipline.

Because of non-standardization and inconsistencies in lower education across jurisdictions, some post secondary departments, e.g., mathematics and English, require entering post secondary students to take one or more placement exams. The placement exams are generally given immediately prior to registration, e.g., when the student has just graduated from a secondary campus is preparing to register for post secondary classes. The placement exams are intended to take students from a variety of programs and jurisdictions and confirm that they are properly placed within the new school's academic program. Still, the placement exams are generally given only once to students entering the subject educational level, i.e., entering a post secondary campus. Within the process of integration of secondary and post secondary it is necessary to evaluate student academic progress through placement exams at least twice a year. In some cases when a student's progress is well advanced then more placement exams are needed to cover additional educational sessions.

In most cases, the grade school is geographically and administratively isolated from the middle school. Likewise, the middle school is geographically and administratively isolated from the secondary, and the secondary is geographically and administratively isolated from the post secondary. The physical separation between levels of education is intentional and done by design. Traditional school administrative thinking prefers to isolate adjacent educational levels to avoid undesirable influences and interaction between the schools. It is generally held that middle school students must be protected from exposure to secondary students, and secondary students do not have the requisite maturity or academic background to be part of the post secondary population. Within the integration process of secondary and post secondary education levels a student is prepared to integrate smoothly through courses work that introduces college study techniques and career preparatory focus. Students that have been introduced properly to the integrated environment do not pose maturity issues and/or academic shortfalls.

As a result, the vast majority of students are herded through a strictly regimented and a traditionally regulated education system, in most cases, regardless of their individual capabilities, aptitudes, and desires. The student completes the ninth grade curriculum before entering the tenth grade, and then completes the tenth grade curriculum before entering the eleventh grade, and then completes the eleventh grade curriculum before entering the twelfth grade, and then completes the twelfth grade curriculum before entering post secondary. Even those individuals who skip a grade, i.e., enroll in a higher grade level in advance of their years; do so by leaving behind the prior curriculum and entering the same basic traditional system, just at a high rung on the educational ladder. Students that jump ahead find themselves in the same basic regimented educational system, just with an older crowd and sometimes lacking the maturity for the uniquely administered level of academic rigors and social interaction. The quantum advance may in fact work against the student as he or she may excel in some subjects and be no better than average in other subjects. The student may quickly find themselves overextended in the subjects of lesser aptitude while trying to function at a level which is higher the across the board of coursework. Within the secondary and post secondary integrated educational program students are prepared to understand and overcome those post secondary academic and maturity rigors before they are scheduled to attend courses.

To avoid such problems, most school administrators adhere to the philosophy that secondary and post secondary are two entirely different institutions, and most students need to stay where they chronologically belong. Most educators believe that there are secondary courses and there are post secondary courses, and academic overlap and joint participation should be minimized. Each educational level (secondary or post secondary) and each grade within such educational level should be discrete traditional steps. Most parents have the same assumption; in part because that is the process they as students went through. Administrators are reluctant to mix and match these discrete educational steps for fear of adversely impacting the progress of the student and upsetting the bureaucracy of the system, i.e., co-mingling between educational levels disturbs the well excepted flow of the system. Post secondary courses are fundamentally different in terms of subject matter, classroom environment, styles of teaching, and expectations of students. Therefore, educators prefer secondary students to have a certain level of academic preparation, age, and maturity in order to increase chances of being successful in post secondary courses. The secondary and post secondary educational integration program prepares administrators and parents to the successes and preparation of the accelerated flow of educational course work.

While there may be some truth or at least reality to this view, the present educational system simply does not reflect individuality of student progress and capability. The present system is fundamentally a regimented traditional program which is designed for the average student to be able to circumscribe. While certain at-risk students may struggle in any system, the exceptional ones are likely held back to the pace of the center of the normal distribution. The result is a system that follows old standards of identification and progression, and becomes a rite of passage more than an optimized educational experience. A basic shortcoming of the present education system is that there is little or no interaction or integration between different levels of education, and indeed a deep rooted bias against such notions. These shortcomings inhibit sound individualized educations that motivate and support M.I. pedagogy for student achievement. The secondary and post secondary educational integration program have motivated without stress the student base to achieve higher levels of academic advancement without limitations founded by the prior traditional educational systems.

### SUMMARY OF THE INVENTION

In one embodiment, the present invention is a method of integrating secondary and post secondary curriculum to allow a student to receive a secondary diploma and earn post secondary credit or diploma, comprising providing a secondary in proximity to or directly on a post secondary campus, or a unique combined use facility evaluating a student to ascertain academic aptitudes and capabilities, assigning a class schedule to the student based on the evaluation of the student, the class schedule having at least one secondary class and at least one post secondary class, and organizing a secondary forum wherein the student attends the secondary class in the secondary and attends the post secondary class on the post secondary campus according to the class schedule or achievement supported by relevant strict criteria.

In another embodiment, the present invention is a computer implemented method of providing a secondary forum integrated with a post secondary curriculum, comprising administering an assessment test to secondary students at least twice per year, evaluating the secondary student based on the assessment test to determine a class schedule based on academic aptitudes and capabilities, the class schedule having a secondary class and a post secondary class, and organizing the secondary forum in a manner to allow the student to attend the secondary class and post secondary class according to the class schedule. Also those students are required to take career planning sessions and college study techniques. These courses help ensure a higher level of social acceptance and less anxiety.

In another embodiment, the present invention is a method of educating a secondary student in a secondary forum located in proximity to a post secondary campus, or a unique combined educational facility comprising assessing academic competence of the secondary student by administering an assessment test before every scheduling of course work, assigning a class schedule to the secondary student based on the academic competence and ability to attend focused and maturely, the class schedule having a secondary class and a post secondary class, organizing the secondary forum so that the secondary student attends the secondary class under the secondary forum and the post secondary class on the post secondary campus, and awarding post secondary credit or diploma to the secondary student upon passing the post secondary class.

In another embodiment, the present invention is an integrating secondary and post secondary program which allows a student to receive a secondary diploma and earn post secondary credit, comprising means for providing a secondary in proximity to a post secondary campus, or a unique combined educational facility means for evaluating a student to ascertain academic aptitudes and capabilities, means for assigning a class schedule to the student based on the evaluation of the student, the class schedule having at least one secondary class and at least one post secondary class, and means for organizing a secondary forum, wherein the student attends the secondary class in the secondary and attends the post secondary class on the post secondary campus according to the class schedule.

### BRIEF DESCRIPTION OF THE DRAWINGS

FIG. 1 illustrates an process of a annual integrated secondary/post secondary educational system;

FIG. 2 illustrates a secondary forum in close proximity to a post secondary campus;

FIG. 3 illustrates the secondary forum co-located in which a student is engaged in two educational processes simultaneously on the post secondary campus;

FIG. 4 illustrates the continuous process of evaluation and placement of student in integrated secondary and post secondary program;

FIG. 5 illustrates results of a first assessment examination; this assessment is repeated in reading, writing, math and science.

FIG. 6 illustrates results of a second assessment examination;

FIG. 7 Illustrates an example of an assessment examination;

FIG. 8 illustrates transcripts of a student transferring from another school;

FIGS. 8a-8b illustrate transcripts of a student completing the integrated secondary and post secondary process;

FIG. 9 illustrates a first secondary lesson plan under the integrated secondary and post secondary curriculum;

FIGS. 10a-10c illustrate a second secondary lesson plan under the integrated secondary and post secondary curriculum;

FIG. 11 illustrates a process of integrating secondary and post secondary curriculum to allow a student to receive a secondary diploma and earn post secondary credit;

FIG. 12 illustrates a general computer system for integrating the secondary and post secondary curriculum; and

FIG. 13 illustrates a computer communication network for integrating the secondary and post secondary curriculum.

FIGS. 14 and 14a illustrates the Secondary/Post Secondary Motivation Theory Equation.

FIG. 15 illustrates the Secondary-Post Secondary Graduate data.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

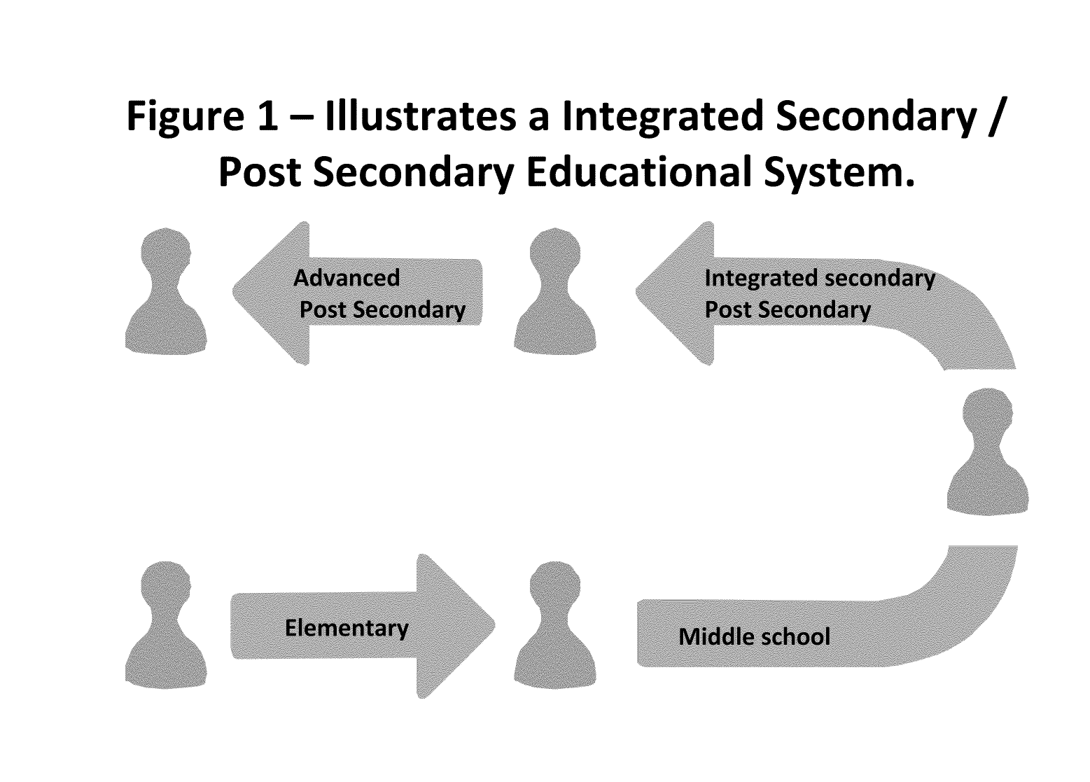

Referring to FIG. 1, an educational system 10 is shown suitable for educating students. The educational system 10 has a grade school level 12, middle school level 14, and integrated secondary and post secondary level 16. While the integration between education levels is shown and described between secondary and post secondary, similar principles can be applied to integration between the grade school level and middle school level, or between the middle school level and the secondary level.

The student enters pre-school or grade school level 12 as a child around the age of 5 or 6 and undertakes the prescribed coursework. Upon demonstrating satisfactory progress under the requisite grade school level coursework, the student advances to middle school level 14. In most jurisdictions, the grade school through middle school levels, i.e., grades 1-8, takes about eight or nine years. The student is exposed to history, geography, sciences, english, mathematics, art, music, as well as other subjects to prepare for the later years. Again, after demonstrating satisfactory progress under the requisite middle school level coursework, the student advances to the integrated secondary and post secondary level 16. In some cases, the student will later proceed to post secondary level 18, which may be a four year university to complete their undergraduate degree and/or pursue post graduate work.

As noted above, the traditional path for students is to complete four years of secondary followed by four years of post secondary. The secondary curriculum has its defined course work, and the post secondary curriculum has its defined course work. While the traditional secondary and post secondary process has been in effect for a long time, it is not the most cost effective or efficient system to educate our youth. In today's mounting competitive workplace, new approaches are needed to improve our educational system.

Educational system 10 provides just such innovative thinking and implementation to help students get a more complete education, possibly in less time.

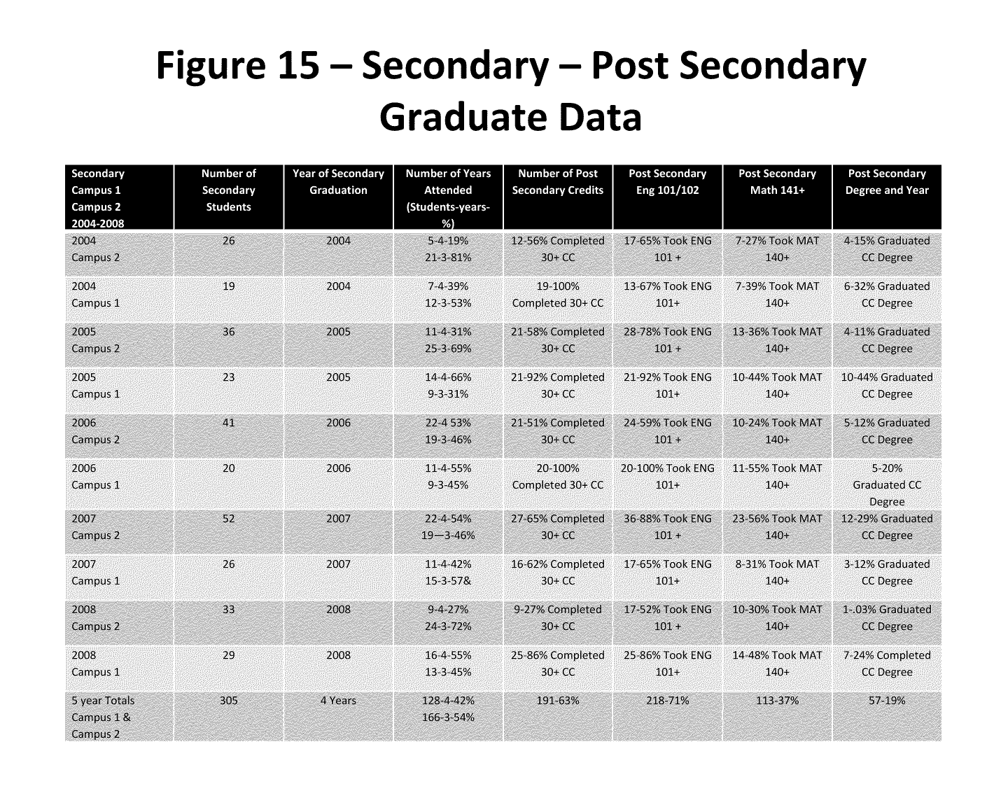

Educational system 10 uses an integrated secondary and post secondary level 16 to provide an effective and efficient academic environment and process for students to simultaneously earn their secondary diploma and post secondary credit. In its basic structure, education combines portions of the secondary curriculum with portions of the post secondary curriculum to give the student the opportunity to graduate secondary with a significant number of earned post secondary credits as noted on FIG. 15. After secondary graduation, the student may formally enter post secondary with the earned post secondary credits which gives the student several options. The student may choose to complete their degree program in less time and potentially start graduate school earlier than could practically have been done under the traditional approach. Since the student is starting post secondary ahead of the game with a certain number of earned post secondary credits, he or she may choose to take additional post secondary courses in excess of the degree requirements during their two or four year post secondary period to increase their overall knowledge base. In another option, the student can take post secondary course work with fewer hours per semester, e.g., to allow time for work, and still graduate in four years. In yet another option, the student may use the post secondary credits earned in secondary to free up time so he or she can focus efforts on multiple programs of study to earn two or more degrees in the same time that the traditional program of study would have provided only one post secondary degree. The idea is not to finish secondary early, but rather to finish with a number of post secondary credits, which will provide the head start in the next level. In any case, educational system 10 makes efficient use of secondary years to prepare the student for post secondary in ways that could not previously have been achieved.

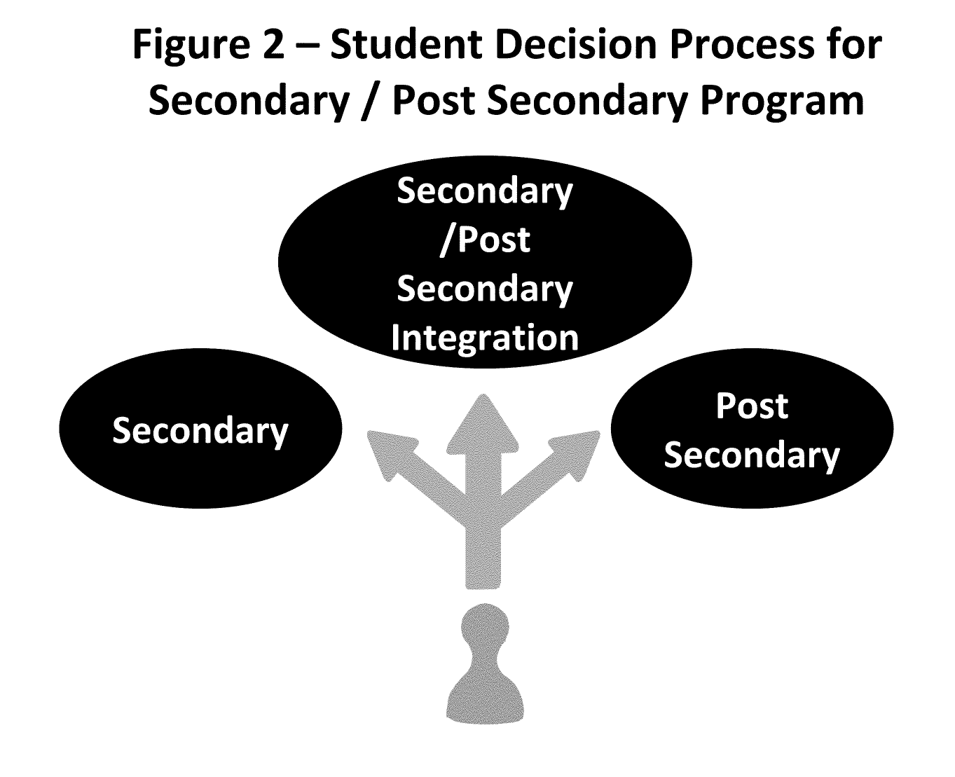

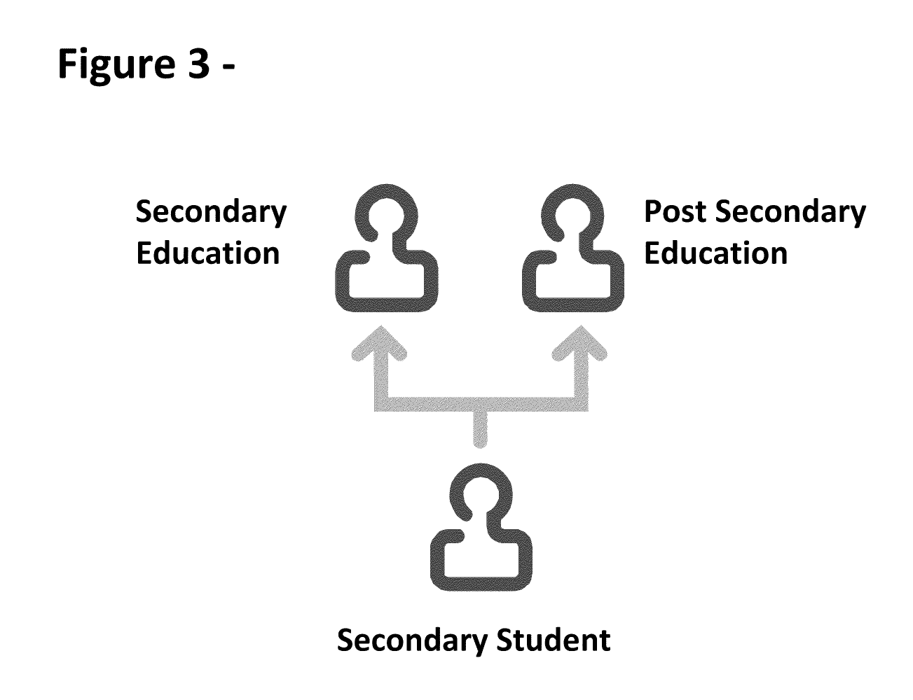

Turning to FIG. 2, assume that student 30 has completed middle school level 14 and elects to enroll in secondary 32, which offers an integrated secondary and post secondary curriculum. In other cases, student 30 transfers from a traditional secondary into integrated secondary 32. In the present example, the secondary 32 is a post secondary preparation charter school, although the same concept applies to any public or private secondary forum. In terms of physical logistics, secondary 32 is located adjacent to or in sufficiently close proximity or in a uniquely combined campus, to post secondary 34 so that student 30 can attend classes in both the secondary classrooms and the post secondary classrooms during the same school day. Alternatively, secondary 32 can be co-located on the same campus as post secondary 34 as shown in FIG. 3. Student 30 may have back-to-back classes in secondary 32 and post secondary 34 and need to be able to physically traverse the distance between the respective classrooms in a practical and safe manner. In the present example, post secondary 34 is a two-year community post secondary, but the same concept applies to a four-year university.

Secondary 32 and post secondary 34 are separate and distinct administrative institutions. Secondary 32 and post secondary 34 each follow the rules, regulation, accreditation, competency, and graduation requirements imposed by their respective governing bodies and state and local laws. The individuals enrolled in secondary 32 are still secondary students and the individuals attending post secondary 34 are post secondary students, each subject to the rules, regulations, requirements, and expectations of their respective institutions. The secondary students 30 are working toward their secondary diploma and the post secondary students are working toward their post secondary degree. As will be seen, the secondary student 30 will graduate from secondary 32 with more than just the diploma. Also seen in FIG. 15 a majority of graduates will complete at least one year (63%) of post secondary course work while an average of (19%) nineteen percent of the graduates will complete one or more two year degrees or two years plus of coursework.

By having secondary forum 32 on the same campus as post secondary 34, the two institutions can share many logistic facilities and resources, such as teachers, food services, student activity center, faculty support services, faculty lounges, administrative offices, buildings, utilities, recreation, grounds, parking, maintenance, janitorial services, safety services, and the like. The tax dollars, endowments, tuition, or other funding used to support post secondary 34 have a corresponding benefit to secondary 32, which provides economies of scale and efficiencies to the education process.

To some degree, secondary 32 must meld its rules, regulations, policies, and operations to match or be compatible with post secondary 34. For example, secondary 32 organizes and operates its class schedules on the same schedule as post secondary 34. Since post secondary 34 generally schedules classes either on Tuesday (U) and Thursday (H) or on Monday (M) and Wednesday (W) and Friday (F), secondary 32 will schedule its classes under the same weekly pattern. Post secondary 34 provides year-round classes; secondary 32 does the same. Secondary 32 follows the same vacation calendar, holidays, seasonal breaks, and days off as post secondary 34. Secondary 32 provides a two week introduction or start-up period prior to each post secondary session. This provides a smooth transition to take place taking into account familiarity, maturity level and positive reinforcement of the program.

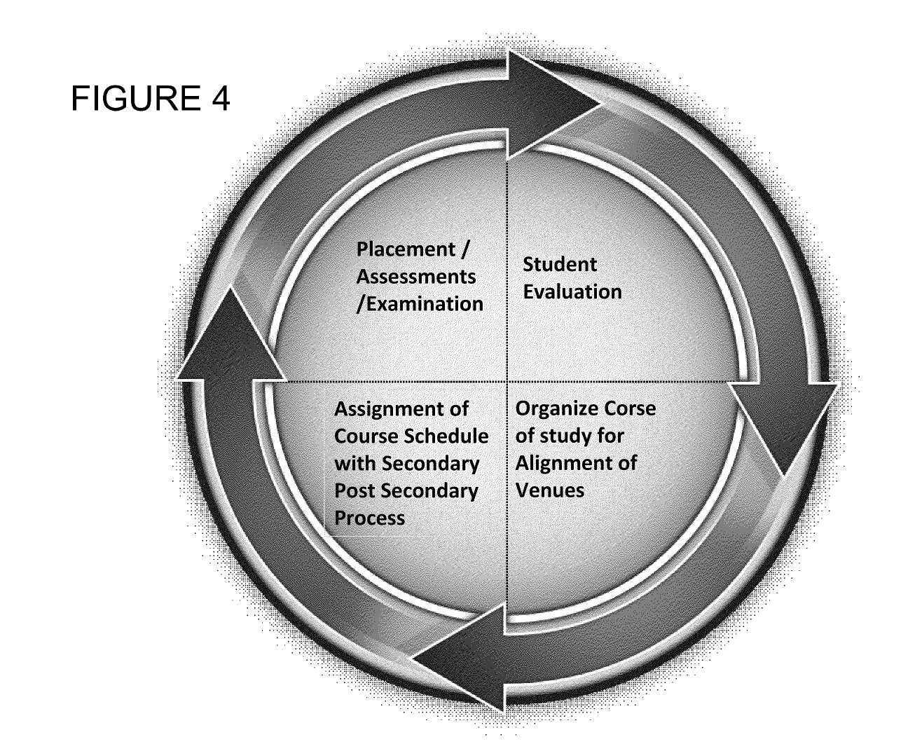

When student 30 enrolls in secondary 32, he or she is given a placement or assessment examination in step 40 as shown in FIG. 4. The purpose of the placement exam step 40 is to determine with relative certainty where the student actually resides in terms of academic progress and basic knowledge and learned skills in certain fundamental areas, such as reading, writing, mathematics, sciences, and humanities. In one embodiment, student 30 takes the entrance or placement exam(s) given by each academic department of post secondary 34. In some post secondary schools, this is known as computer adaptive placement assessment (Compass) testing. Compass testing is a comprehensive computerized evaluation that provides important information about individual skills and preparation for post secondary-level courses. The examination is an un-timed, multiple choice, adaptive computer-based test that measures relative skills in at least reading, writing, and mathematics. The Accuplacer, State Instrument test and prior transcripts shows the student's score in each tested subject area and automatically generates specific recommendations as to the proper secondary or post secondary classes in which to place the student.

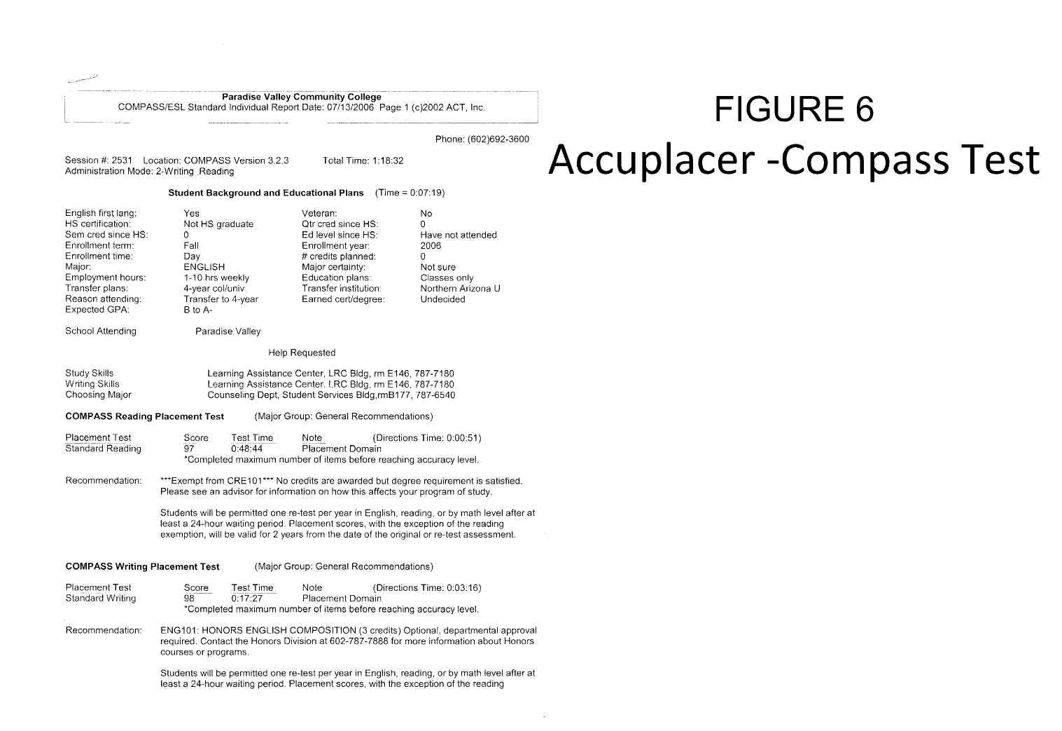

An example of accuplacer test 50 is shown in FIG. 6. Section 52 contains general background information about the student such as name, identification, prior schools, English as first language, veteran status, etc. Section 54 provides the student's score on the mathematics portion of the test and makes a recommendation for the proper post secondary level math class, e.g., MAT 081/081, MAT 090/091/092, or MAT 102. Section 56 provides the student's score on the post secondary level reading portion of the test and makes a recommendation for the proper reading class, e.g. RDG 091. Section 58 provides the student's score on the writing portion of the test and makes a recommendation for the proper post secondary level writing class, e.g., ENG 101. If the student's assessment test scores are insufficient to qualify for any post secondary class, then a recommendation is made for the secondary classes and other special or remedial classes needed to prepare the student for post secondary level classes.

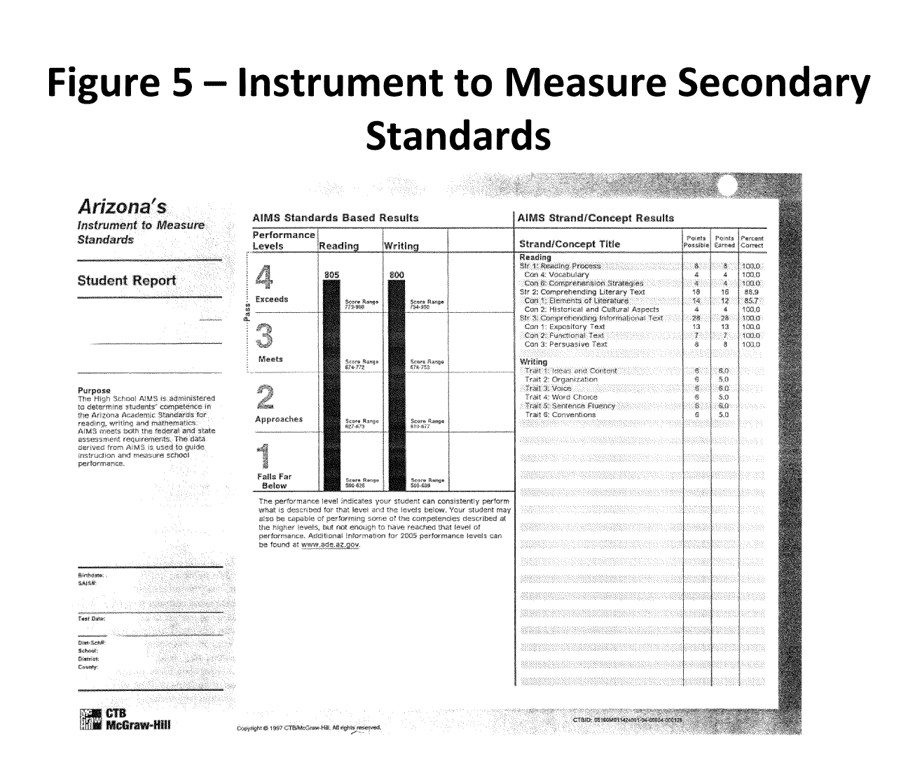

Student 30 may also be given other state and national assessment exams, such as the Arizona Instrument to Measure Standards (AIMS) test and Stanford Achievement Test Ninth Edition (Stanford 9) test. An example of AIMS test 60 is shown in FIG. 5. Section 62 contains general background information about the student such as name, identification, prior schools, district, county, etc. Section 64 provides the student's score on the mathematics portion of the test and provides relative standing with respect to other students. Section 66 provides the student's score on the post secondary level reading portion of the test and provides relative standing with respect to other students. Section 68 provides the student's score on the writing portion of the test and provides relative standing with respect to other students. Other state and national placement or assessment exams also give the student score, relative position to other test takers, and general comments.

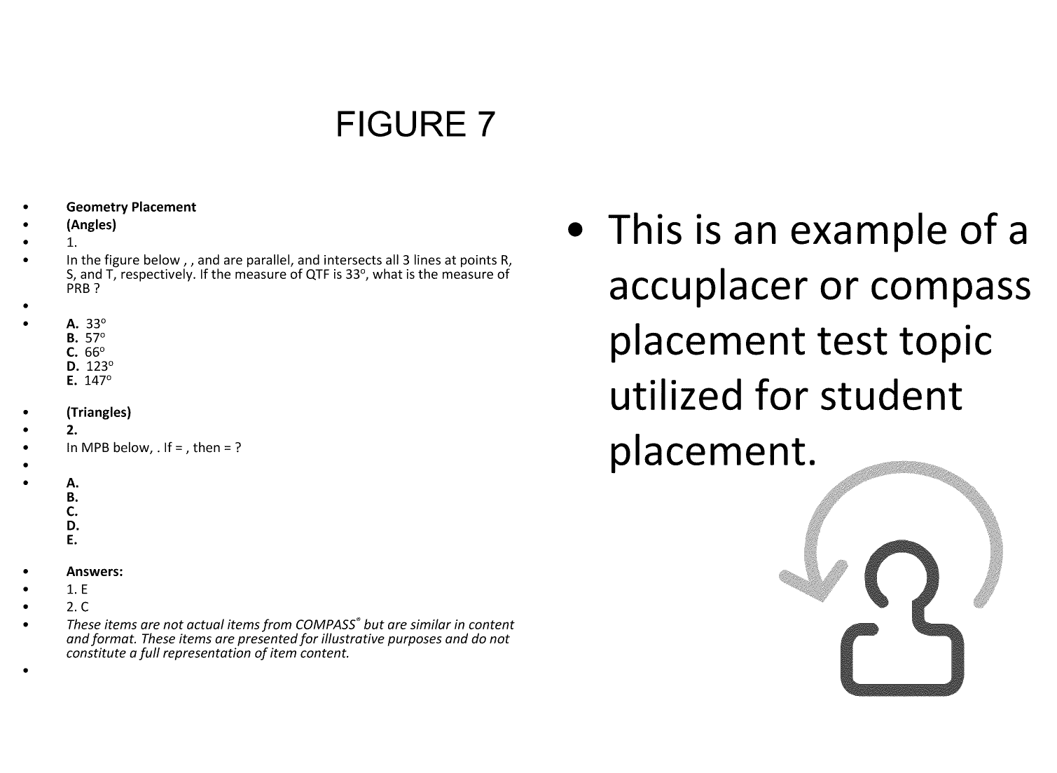

The principal, guidance counselor, or administrator in secondary 32 conducts student evaluation in step 42 of FIG. 4 to determine the student's class schedule. The student evaluation step 42 includes consideration of multiple evaluation components, such as placement and assessment exams 40, prior academic transcripts, comments and feedback from prior teachers, interests and goals of the student, and consultation with the parents. An example of prior school transcripts is shown in FIG. 7. Transcripts 70 are illustrative of the course work and achievements of a student transferring from another traditional secondary. Section 72 contains general information about the student; section 74 shows grades from one semester; and sections 76-84 shows grades from other semesters.

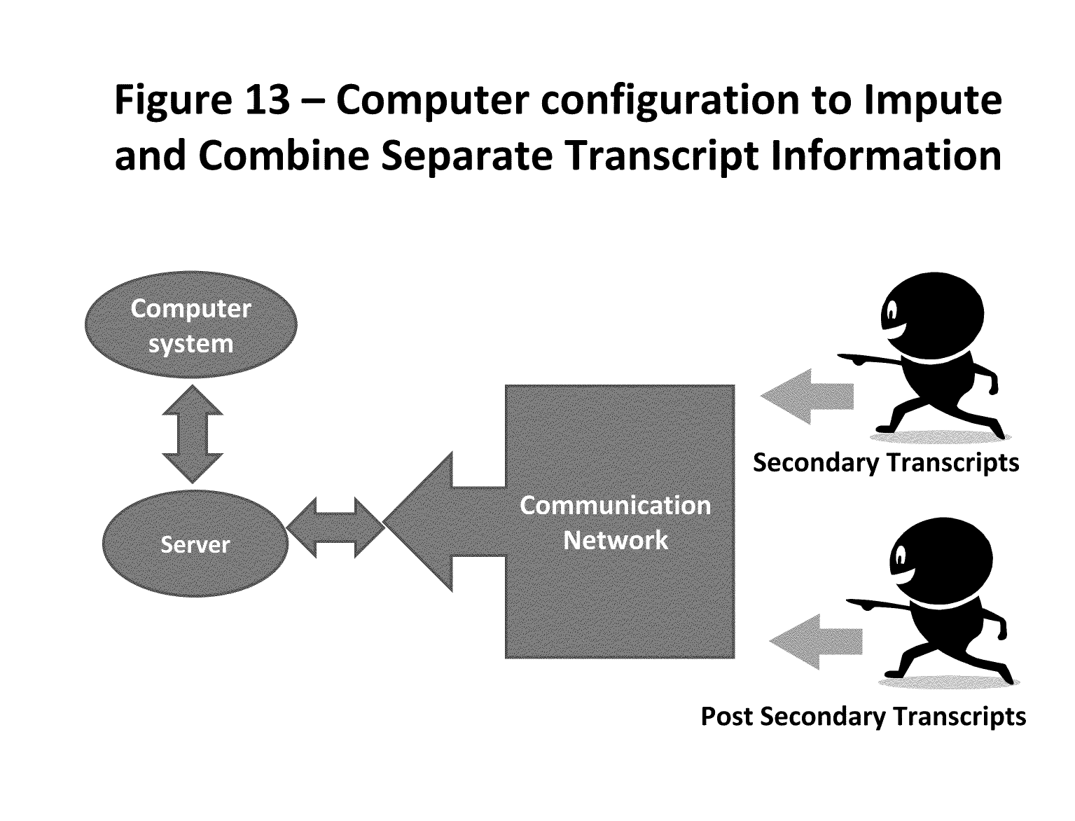

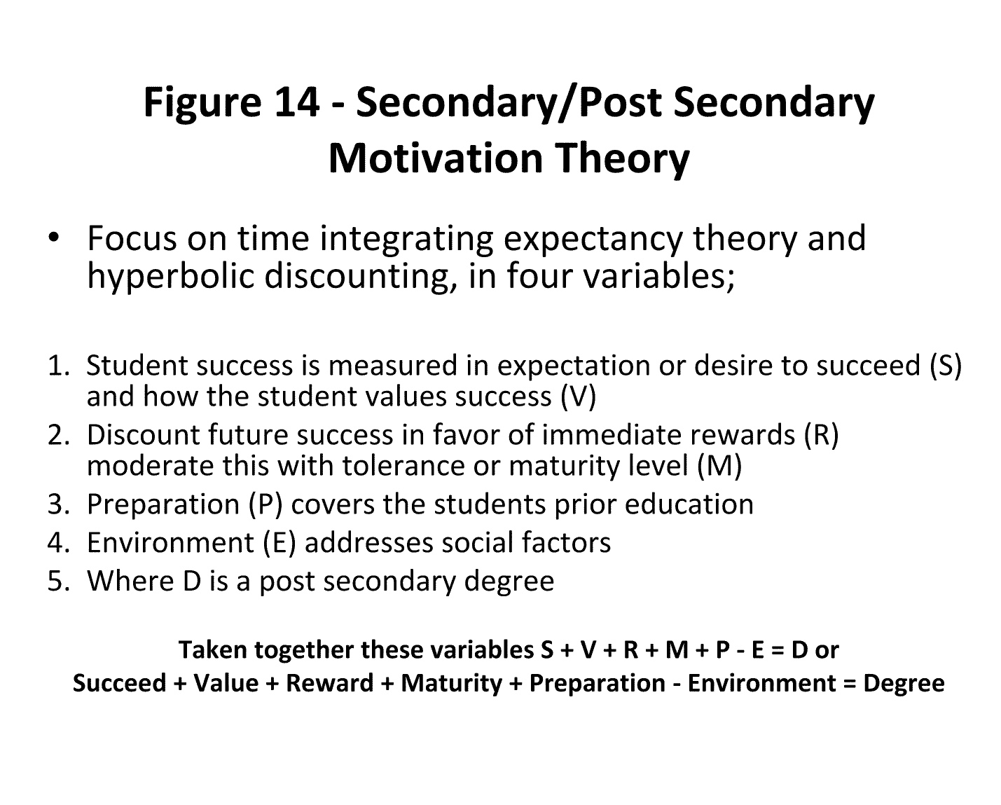

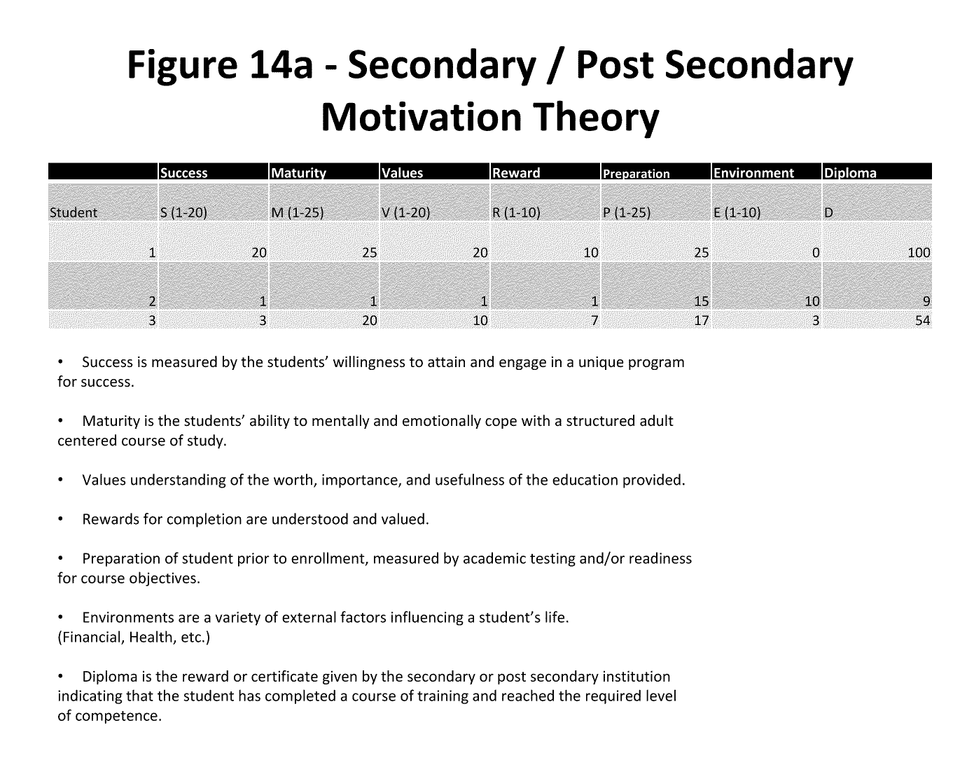

The components of student evaluation 42 give the administrator of secondary 42 the ability to compare and contrast various evaluation data points. One evaluation component alone may be misrepresentative or misleading. The Secondary/Post Secondary Motivation Theory (FIG. 13) helps the administrator, student and parent evaluate other significant data in the evaluation process. The recommendations from the placement test alone are not necessarily determinative, rather it is the combination of the evaluation components, including one or more placement tests and prior school transcripts, as well as discussions with the parents and student (FIG. 13 & FIG. 14), that gives secondary 32 the most complete, accurate, and reliable evaluation of the strengths and weakness of student 30. Sometimes the best interests of the student require the administrator to override the recommendation and enroll the student in another course. The student evaluation step 42 is performed before each educational session every academic year to track progress.

Based on student evaluation 42, the administrator of secondary 32 makes a judgment and decision as to the student's class schedule. When a close judgment call must be made between secondary and post secondary class options, the administrator considers maturity, exposure to life experiences, and comfort level (FIG. 13 & FIG. 14) of the student in talking to post secondary professors before committing the student to the post secondary class, while always keeping in mind the best interests and placement of the student. In some cases, secondary 32 gives student 30 special tutoring on specific subjects, remedial classes, and counseling to complete the prerequisites for post secondary classes. Within reason and without adversely impacting the student's development, secondary 32 attempts to get student 30 enrolled in one or more post secondary classes as soon as possible and to take as many post secondary classes as can reasonable be done during their secondary years.

One goal of secondary 32 is to place student 30 in some combination of secondary classes and post secondary classes. The close physical proximity of secondary 32 and post secondary 34 makes the integrated curriculum possible. To the extent that student 30 can take a post secondary class that covers at least the same subject matter as a similar secondary class, then the student makes progress toward the secondary diploma while earning post secondary credit. For example, if the student qualifies to take post secondary freshman English 101, then that coursework will satisfy the secondary English requirement toward the secondary diploma as well as earn the post secondary credit. Likewise, if the student qualifies to take post secondary freshman Algebra, then that coursework will satisfy the secondary mathematics requirement toward the secondary diploma as well as earn the post secondary credit. In most cases, the more difficult and comprehensive class of a common subject offered by the post secondary serves to satisfy both the secondary requirement and the post secondary requirement. Rather than take two classes at different times as found in traditional educational systems, i.e., one class in secondary and one class in post secondary for the same subject, student 30 takes one class in secondary 32, the more difficult and comprehensive post secondary class for the requisite course, for both secondary and post secondary graduation requirements. The student 30 still takes some secondary classes and some post secondary classes. When student 30 is a secondary freshman, the ratio of secondary classes to post secondary classes may be 90:10. As student 30 reaches their secondary senior year, the ratio of secondary classes to post secondary classes may be 10:90. Nonetheless, by taking a combination of secondary course work and post secondary course work, the student 30 progresses at a rate that challenges their personal development.

Student 30 can expect a more rigorous academic experience under the integrated secondary and post secondary program. Post secondary course work is across the board more difficult and challenging than secondary course work. In post secondary course work, student 30 can expect more hours of homework, faster paced classes, less personal attention from instructors, more difficult class examinations, and great depth of coverage and complexity of subject matter. Yet, the advantages and gains made by student 30 will pay dividends in terms of academic progress, preparation for post secondary, and earning of post secondary credits while still in secondary. For those students willing to put forth the effort, the rewards will materialize. If the secondary student is capable, interested, and properly motivated, then he or she should be allowed to advance on an individual basis. The integrated secondary and post secondary program provides the student such opportunities.

Secondary 32 offers specialized student instruction, counseling, and aids to prepare secondary student 30 to take post secondary classes and otherwise function as post secondary students. The secondary student 30 learns post secondary study skills, social interaction skills, time management skills, basic computer skills, and career development skills. These skills can be reinforced yearly during the two week start-up or post sessions offered prior to each post secondary session. The secondary student learns how to read a post secondary syllabus and how to talk to post secondary professors. The student aids and special instruction lessens the shock and increases the chances of secondary student 30 being successful in the post secondary experience.

In step 44 of FIG. 4, the administrator of secondary 32 assigns student 30 his or her class schedule in accordance with the student evaluation 42. The student's class schedule will contain secondary course work and post secondary course work depending on his or her aptitude, motivation, and strengths as well as consideration of areas needing further development. A freshman may have 4-5 secondary classes and 1-2 post secondary classes. The post secondary classes will be in subjects that satisfy the post secondary requirement as well as a secondary requirement. Student 30 attends classes during the semester according to the integrated secondary and post secondary class schedule. The student may be in a secondary English class on MWF 9:00 am to 10:00 am and a post secondary computer skills class MWF 10:30 to 11:30 am. The student may also be in a secondary history class on UT 8:00 am to 9:30 am and a post secondary biology class UT 10:00 to 11:30 am and a secondary drama class on UT 1:30 to 3:00 pm. The close proximity of secondary 32 to post secondary 34 allows student 30 to move back and forth between classes. Again, the secondary classes are held according to the post secondary type class schedule.

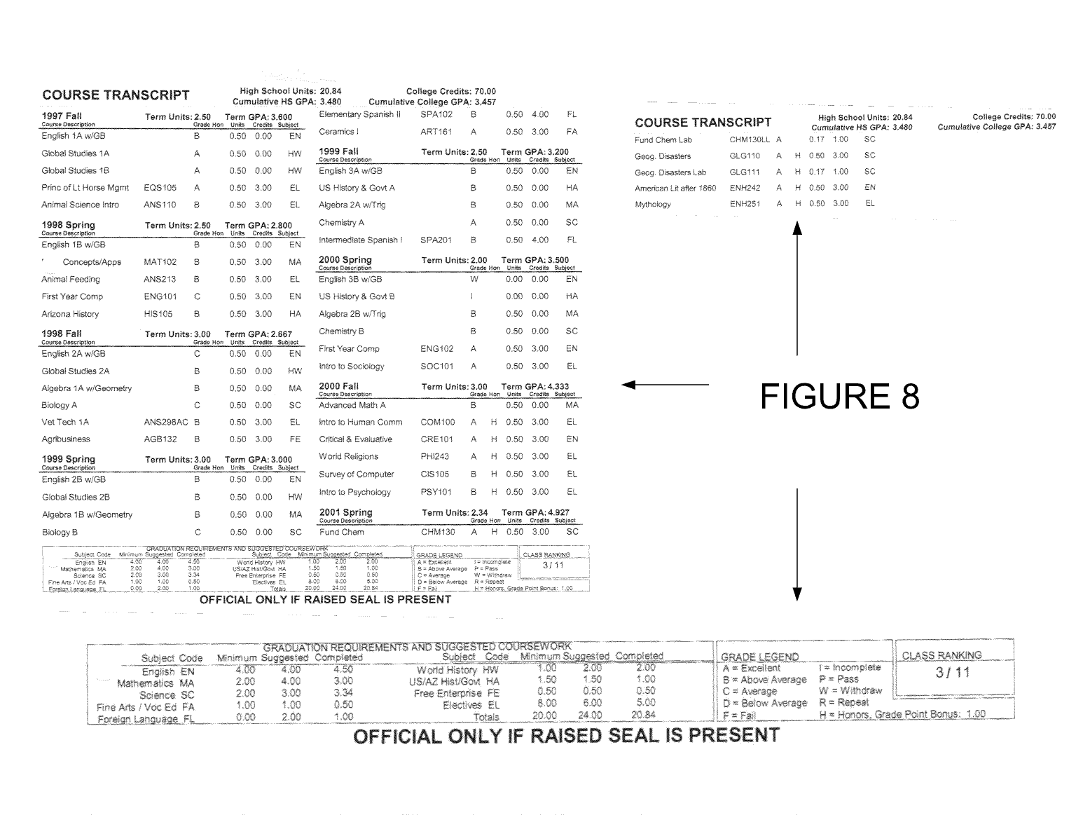

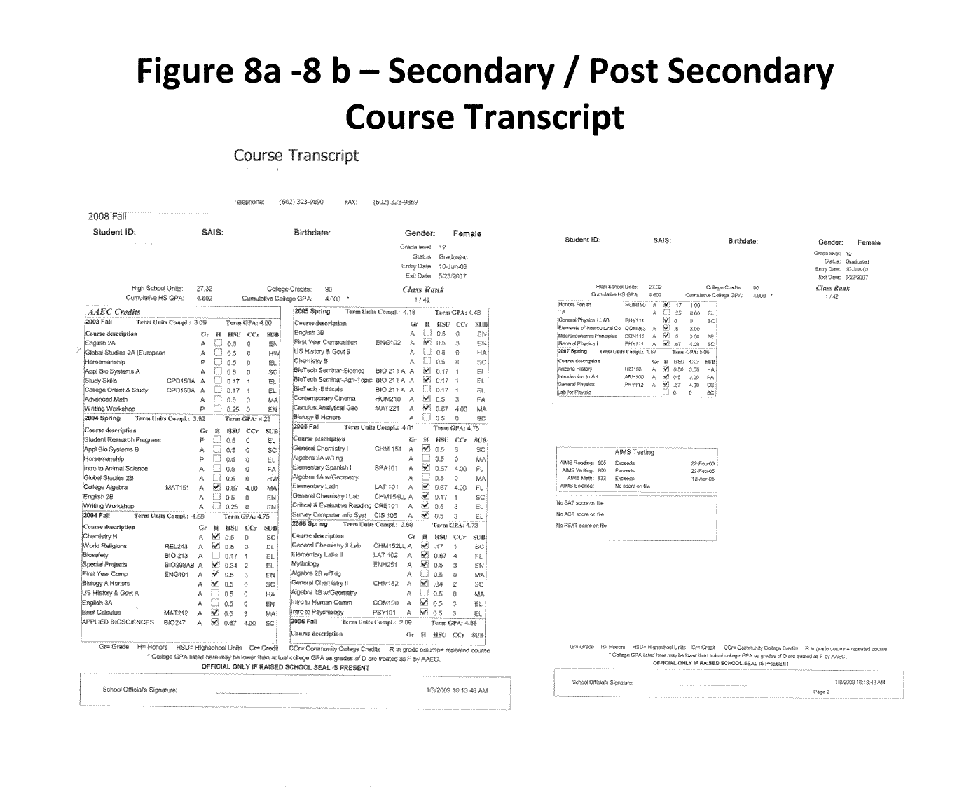

FIGS. 8a and 8b illustrate a secondary transcript 90 of student 30 having taken a combination of secondary classes and post secondary classes simultaneously over several semesters. For example, class 92 is a secondary course and class 94 is a post secondary course. In most cases, each semester has at least one secondary course and at least one post secondary class. The ratio of post secondary courses to secondary classes increases as the student works through the integrated secondary and post secondary curriculum.

The post secondary preparatory charter secondary forum 32 may also offer specialized classes of career paths and interest to the student. Secondary 32 may offer special expertise or concentrations in biotechnology, electronics, drama, music, or architecture, just to name a few. In the present example, secondary 32 offers biotechnology classes in areas such as genetics, botanical gardens, and bio systems. The specialized classes give students an exposure to real world workplaces and industry issues.

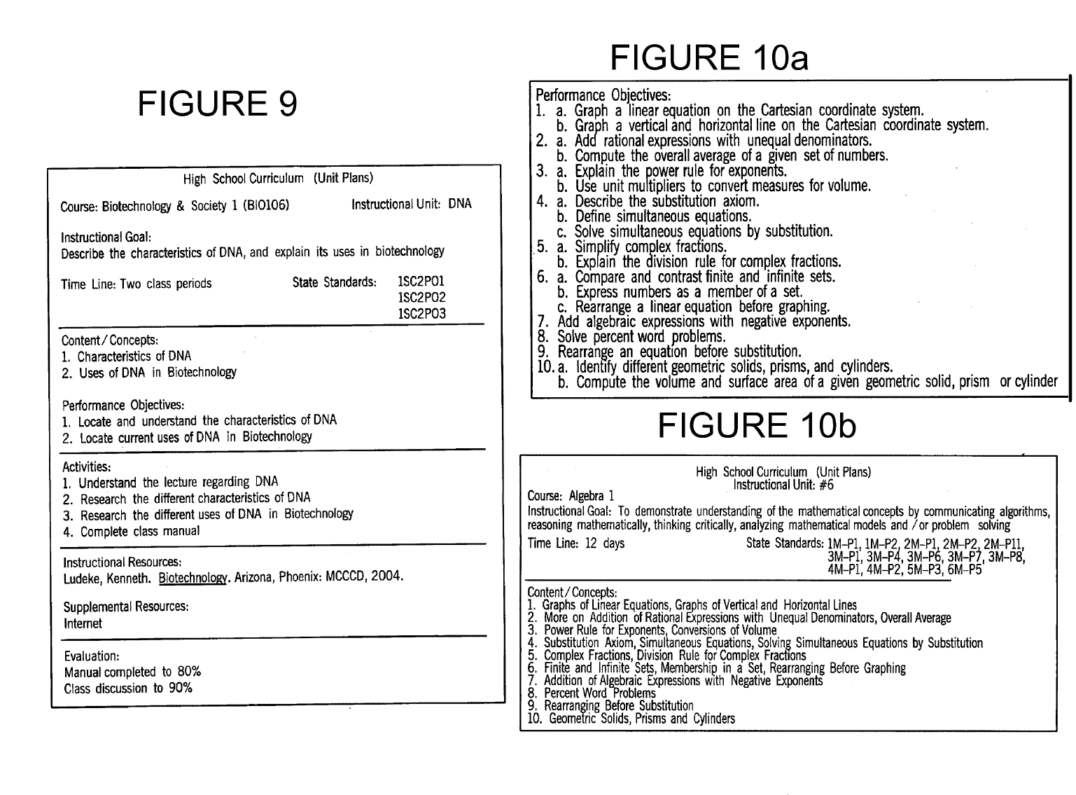

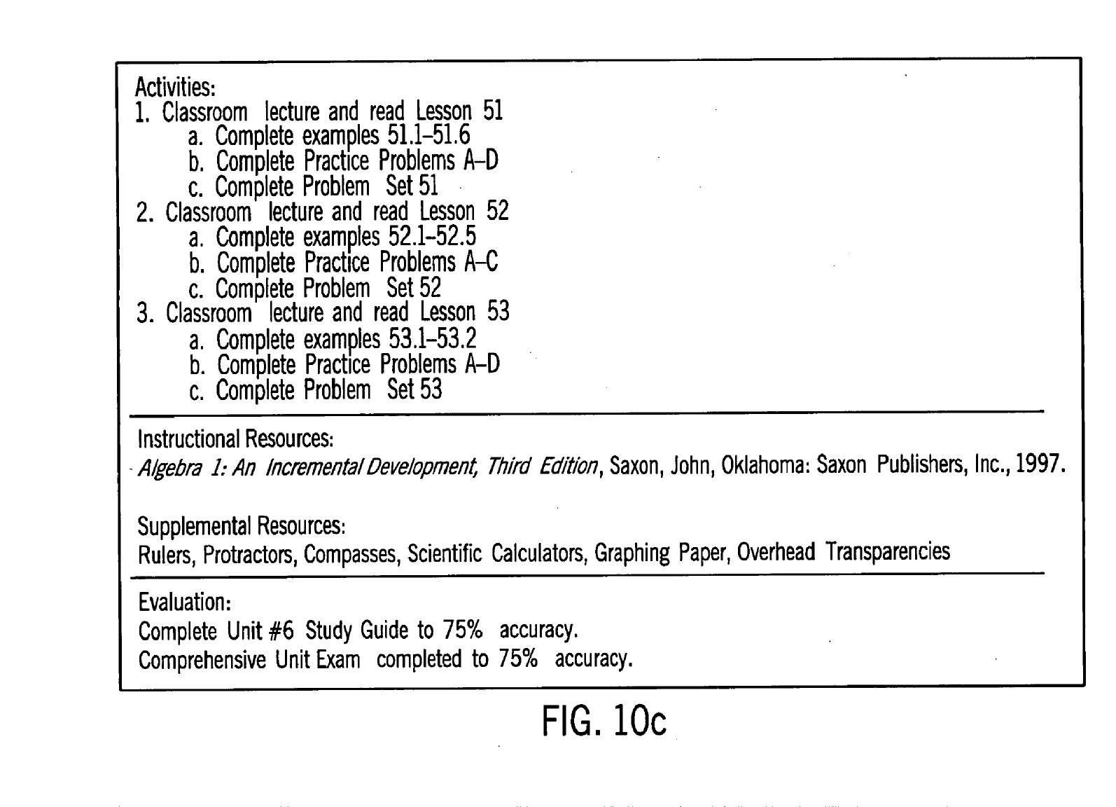

The selection of staff is important to secondary 32. Because of its unique approach, secondary 32 attracts highly qualified staff and instructors. Teachers migrate to schools where students want to learn and where they have the freedom to teach in an effective, efficient, and flexible environment. Each year, secondary 32 reviews its curriculum and makes changes as necessary to maintain compatibility with post secondary 34 and keep its students challenged and motivated. FIG. 9 illustrates a lesson plan 100 for a biotechnology class offered in secondary 32. FIGS. 10a-10c illustrate a lesson plan 110 for an algebra class offered in secondary 32. The lesson plans 100 and 110 give general guidelines for the instructors, but also allow for flexibility in the manner that the subject is conveyed to the students. Teachers are in the best position to gauge how the students are absorbing the course material and whether to speed up or slow down to optimize the progress. Most teachers appreciate having the freedom to teach.

By the time student 30 graduates from secondary 32 with sufficient credits to meet the state secondary graduation requirements, he or she can also have a significant number of post secondary credits. In some cases, student 30 can earn 60 or more post secondary credits during a four year secondary period. The post secondary credits are transferable into most, if not all, post secondary or four year universities. The earned post secondary credits can be used for the benefit of the student in a variety of ways to enhance the post secondary experience.

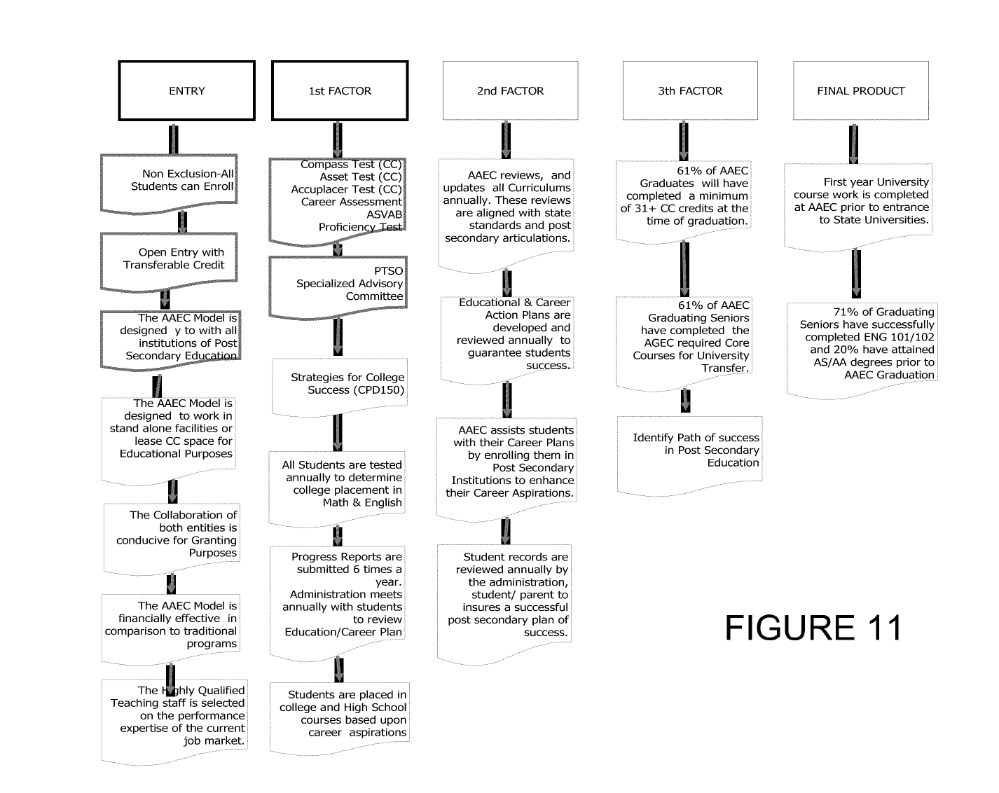

The process of integrating secondary and post secondary curriculum to allow a student to receive a secondary diploma and earn post secondary credit is shown in FIG. 11. In step 120, the secondary is located in proximity to a post secondary campus. The secondary and post secondary share resources and facilities. In step 122, the student is evaluated to ascertain academic aptitudes and capabilities. The student is evaluated by administering a post secondary placement exam and by reviewing prior school transcripts. In step 124, a class schedule is assigned to the student based on the evaluation of the student. The class schedule has at least one secondary class and at least one post secondary class. The class schedule is assigned by an administrator of the secondary based on the evaluation of the student. The secondary class is scheduled in accordance with the post secondary class. In step 126, the secondary forum is organized and operates so as to allow the student to attend the secondary class in the secondary and attends the post secondary class on the post secondary campus according to the class schedule. The secondary offers special classes for the student to adapt to the post secondary class. In step 128, the secondary student earns post secondary credit upon passing the post secondary class.

The integrated secondary and post secondary program can be implemented as one or more software applications or computer programs residing and operating on a computer system. The computer system may be a stand-alone unit or part of a distributed computer network. The computer is typically electronically interconnected with other computers using communication links such as Ethernet, radio frequency (RF), satellite, telephone lines, optical, digital subscriber line, cable connection, wireless, and other recognized communication standards. The electronic connection link between computers can be made through an open architecture system such as the World Wide Web, commonly known as the Internet. The Internet offers a significant capability to share information, data, and software. Within a secondary-post secondary integrated program it is imperative to have a software process that combines the transcript information to include secondary and post secondary completed course work. (FIG. 8a and FIG. 8b)

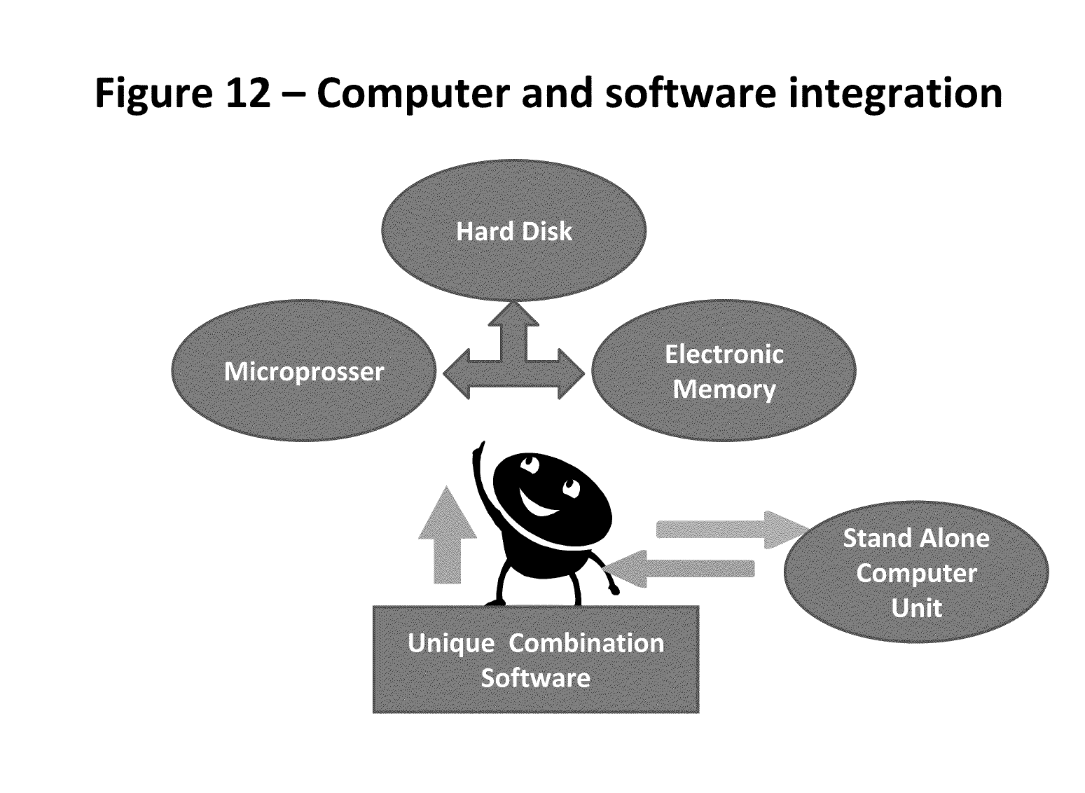

FIG. 12 illustrates a simplified computer system 150 for executing the software program used in integrating the secondary and post secondary curriculums. Computer system 150 is a general purpose computer including a central processing unit or microprocessor 152, mass storage unit or device and hard disk 154, electronic memory 156, and communication port 158. Communication port 158 represents a modem, high-speed Ethernet link, or other electronic connection to transmit and receive input/output (I/O) data with respect to other computer systems. This must be a standalone computer unit that cannot be accessed by outside sources to secure the individual data combination from both institutions as provided for legal formal transcripts. (FIG. 8a & FIG. 8b)

In FIG. 13, an alternate computer 150 is shown connected to server 160 by way of communication port 158, which in turn is connected to communication network 162. Server 160 operates as a system controller and includes mass storage devices, operating system, and communication links for interfacing with communication network 162. Communication network 162 can be a local and secure communication network such as an Ethernet network, global secure network, or open architecture such as the Internet. Computer systems 164 and 166 can be configured as shown for computer 160 or dedicated and secure data entry terminals. Computers 164 and 166 are also connected to communication network 162. Computers 160, 164, and 166 transmit and receive information and data over communication network 162.

Each of the computers runs application software and computer programs as well as the unique software utilized, which can be used to display user interface screens, execute the functionality, and provide the features as described above. The software is originally provided on computer readable media, such as compact disks (CDs), magnetic tape, or other mass storage medium. Alternatively, the software is downloaded from electronic links such as the host or vendor website. The software is installed onto the computer system hard drive 154 and/or electronic memory 156, and is accessed and controlled by the computer's operating system. Software updates are also electronically available on mass storage medium or downloadable from the host or vendor website. The software, as provided on the computer readable media or downloaded from electronic links, represents a computer program product usable with a programmable computer processor having a computer readable program code embodied therein. The software contains one or more programming modules, subroutines, computer links, and compilation of executable code which performs the functionality of the integrated secondary and post secondary program. The user interacts with the software via keyboard, mouse, voice recognition, and other user interface devices to the computer system.

The software stores information and data generated by the integrated secondary and post secondary program in a database or file structure located on any one of, or combination of, hard drives 84 of the computers 150, 164, 166, and/or server 160. More generally, the information generated during the process of conducting an integrated secondary and post secondary curriculum can be stored on any mass storage device accessible to the computers 150, 164, 166, and/or server 160. The mass storage device for storing data from the integrated secondary and post secondary program may be part of a distributed computer system.

The integrated secondary and post secondary program offers many advantages for the student and schools alike. The student remains challenged and motivated, progresses much faster, receives their secondary diploma, earns post secondary credits, and has a high probability of actually attending post secondary after secondary and doing well. By integrating secondary and post secondary, the students are in a sense automatically drawn into the post secondary scene after secondary by the inertia of the program. The fact of having post secondary credits under one's belt is motivation and incentive to continue on to earn the post secondary degree, i.e., it almost takes more effort to stop than to keep going. The post secondary credits themselves have limited value until the student turns them into a post secondary degree. Most students are reluctant to give up post secondary credits that they have already earned, so the natural step is to continue on to post secondary.

The secondary benefits from the integrated secondary and post secondary program by sharing logistical resources with the post secondary, reducing overall student load as the post secondary classes serve the purpose of satisfying both secondary and post secondary requirements, providing an enjoyable teaching environment, and keeping the students interested and progressing.

### APPENDIX

### Secondary-Post Secondary Educational Collaboration

The entire process must be precisely geared together for students to move smoothly through the process designed. Motivation for the student to be intrinsic or expressive the characteristics of the educational program must be satisfying and tangible without negative or disruptive consequences. Students whom have followed the educational program develop a significant commitment to achieving educational goals.

Remove but one gear or point in the natural progression of the educational program and the process is interrupted discontinuing the student's maximum potential or motivation to the students' educational commitment. Achievements rest on strict criteria of relevance to the individual and ease of maximization of educational progress. Removal of one factor may cause students to lose sight of aspirations in education or individual aspirations may change without criteria of relevance to education.

The entire education program seamlessly initiates a student's individual drive through multiple intelligence profiles.

The secondary education and post secondary education collaborative program allows students to develop or advance at their individual intellectual uniqueness in this educational process.

Abraham H. Maslow concentrated on human potential for self actualization which closely models motivation by intrinsic or extrinsic proposes. The education system and method of integrating levels of educational programs supports and documents the success of unique yet complex process of education motivation. One level or gear removed would hinder the potential progress.

System and Method of Integrating Levels of Individual Educational Plan
1. Location of facility.
2. Student evaluation of individual educational plan.
3. Implement course schedule based on individual motivation and educational progress.
4. Synchronize educational plans and schedule to best assist student in educational plan.
5. Award tangible achievement for educational relevance.
6. Continue lifelong learning process.

Secondary and Post Secondary Integration Process Results From 2004-2008

| | | | Number of | | | | |
|---|---|---|---|---|---|---|---|
| Secondary | | | Years | Number of | Post | | Post |
| Campus 1 | Number of | Year of | Attended | Post | Secondary | Post | Secondary |
| Campus 2 | Secondary | Secondary | (Students- | Secondary | Eng | Secondary | Degree |
| 2004-2008 | Students | Graduation | years-%) | Credits | 101/102 | Math 141+ | and Year |
| 2004 | 26 | 2004 | 5-4-19% | 12-56% | 17-65% | 7-27% | 4-15% |
| Campus 2 | | | 21-3-81% | Completed | Took ENG | Took MAT | Graduated |
| | | | | 30+ CC | 101+ | 140+ | CC Degree |
| 2004 | 19 | 2004 | 7-4-39% | 19-100% | 13-67% | 7-39% | 6-32% |
| Campus 1 | | | 12-3-53% | Completed | Took ENG | Took MAT | Graduated |
| | | | | 30+ CC | 101+ | 140+ | CC Degree |
| 2005 | 36 | 2005 | 11-4-31% | 21-58% | 28-78% | 13-36% | 4-11% |
| Campus 2 | | | 25-3-69% | Completed | Took ENG | Took MAT | Graduated |
| | | | | 30+ CC | 101+ | 140+ | CC Degree |
| 2005 | 23 | 2005 | 14-4-66% | 21-92% | 21-92% | 10-44% | 10-44% |
| Campus 1 | | | 9-3-31% | Completed | Took ENG | Took MAT | Graduated |
| | | | | 30+ CC | 101+ | 140+ | CC Degree |
| 2006 | 41 | 2006 | 22-4 53% | 21-51% | 24-59% | 10-24% | 5-12% |
| Campus 2 | | | 19-3-46% | Completed | Took ENG | Took MAT | Graduated |
| | | | | 30+ CC | 101+ | 140+ | CC Degree |
| 2006 | 20 | 2006 | 11-4-55% | 20-100% | 20-100% | 11-55% | 5-20% |
| Campus 1 | | | 9-3-45% | Completed | Took ENG | Took MAT | Graduated |
| | | | | 30+ CC | 101+ | 140+ | CC Degree |
| 2007 | 52 | 2007 | 22-4-54% | 27-65% | 36-88% | 23-56% | 12-29% |
| Campus 2 | | | 19-3-46% | Completed | Took ENG | Took MAT | Graduated |
| | | | | 30+ CC | 101+ | 140+ | CC Degree |
| 2007 | 26 | 2007 | 11-4-42% | 16-62% | 17-65% | 8-31% | 3-12% |
| Campus 1 | | | 15-3-57& | Completed | Took ENG | Took MAT | Graduated |
| | | | | 30+ CC | 101+ | 140+ | CC Degree |
| 2008 | 33 | 2008 | 9-4-27% | 9-27% | 17-52% | 10-30% | 1-.03% |
| Campus 2 | | | 24-3-72% | Completed | Took ENG | Took MAT | Graduated |
| | | | | 30+ CC | 101+ | 140+ | CC Degree |
| 2008 | 29 | 2008 | 16-4-55% | 25-86% | 25-86% | 14-48% | 7-24% |
| Campus 1 | | | 13-3-45% | Completed | Took ENG | Took MAT | Completed |
| | | | | 30+ CC | 101+ | 140+ | CC Degree |
| 5 year | 305 | 4 Years | 128-4-42% | 191-63% | 218-71% | 113-37% | 57-19% |
| Totals | | | 166-3-54% | | | | |
| Campus 1 | | | | | | | |
| Campus 2 | | | | | | | |

Secondary/Post Secondary Motivation Theory

Focus on time integrating expectancy theory and hyperbolic discounting, in six variables;
1. Student success is measured in expectation or desire to succeed (S).
2. How the student values success (V).
3. Discount future success in favor of immediate rewards (R).
4. Moderate this with tolerance or maturity level (M).
5. Preparation (P) covers the student's prior education.
6. Environment (E) addresses social factors.
   Where D is a post secondary degree
   Taken together these variables S+V+R+M+P−E=D or Succeed+Value+Reward+Maturity+Preparation−Environment add up to the probability of a Degree.

Secondary/Post Secondary Motivation Data

| | Success | Maturity | Values | Reward | Preparation | Environment | Diploma |
|---|---|---|---|---|---|---|---|
| Student | S (1-20) | M (1-25) | V (1-20) | R (1-10) | P (1-25) | E (1-10) | D |
| 1 | 20 | 25 | 20 | 10 | 25 | 0 | 100 |
| 2 | 1 | 1 | 1 | 1 | 15 | 10 | 9 |
| 3 | 3 | 20 | 10 | 7 | 17 | 3 | 54 |

Success is measured by the students' willingness to attain and engage in a unique program for success.
Maturity is the students' ability to mentally and emotionally cope with a structured adult centered course of study.
Values understanding of the worth, importance, and usefulness of the education provided.
Rewards for completion are understood and valued.
Preparation of student prior to enrollment, measured by academic testing and/or readiness for course objectives.
Environments are a variety of external factors influencing a student's life. (Financial, Health, etc.)
Diploma is the reward or certificate given by the secondary or post secondary institution indicating that the student has completed a course of training and reached the required level of competence.
   The total S+V+R+M+P−E=D or Succeed+Value+Reward+Maturity+Preparation−Environment add up to the probability of a Degree.

A student with a fifty percent or higher percentage indicates a higher likelihood of success within an educational process. The evaluation of data is completed by a trained professional educator, student and parent in combination to ensure understanding of process of evaluation.

While one or more embodiments of the present invention have been illustrated in detail, the skilled artisan will appreciate that modifications and adaptations to those embodiments may be made without departing from the scope of the present invention as set forth in the following claims.

What is claimed is:

1. A method of integrating secondary and post secondary curriculum to allow a student to receive a secondary diploma and earn post secondary credit, comprising:
providing a secondary in proximity to a post secondary campus; or a uniquely combined campus;
evaluating a student to ascertain academic aptitudes and capabilities;
assigning a class schedule to the student based on the evaluation of the student, the class schedule having at least one secondary class and at least one post secondary class; and
organizing a secondary forum, wherein the student attends the secondary class in the secondary and attends the post secondary class on the post secondary campus according to the class schedule.

2. The method of claim 1, wherein the student earns secondary and post secondary credit upon passing the qualified post secondary class.

3. The method of claim 1, wherein evaluating the student includes administering a post secondary placement exam.

4. The method of claim 1, wherein evaluating the student includes reviewing prior school transcripts.

5. The method of claim 1, wherein the secondary is co-located on the post secondary campus; or a unique constructed combined campus.

6. The method of claim 5, wherein the secondary and post secondary share resources and facilities.

7. The method of claim 1, wherein the secondary class is scheduled in accordance with the post secondary class.

8. The method of claim 1, further including offering special classes and/or post sessions for the student to adapt to the post secondary class.

9. The method of claim 1, wherein the class schedule is assigned by an administrator of the secondary based on the evaluation of the student.

10. A computer implemented method of providing a secondary forum integrated with a post secondary curriculum, comprising:
administering an assessment test to secondary students at least twice per year; or more if student attends extra sessions.
evaluating the secondary student based on the assessment test to determine a class schedule based on academic aptitudes and capabilities, the class schedule having a secondary class and a post secondary class; and
organizing the secondary forum in a manner to allow the student to attend the secondary class and post secondary class according to the class schedule.

11. The computer software implemented method of claim 10, further including providing the secondary forum in proximity to a post secondary campus.

12. The computer software implemented method of claim 10, wherein the student earns post secondary credit upon passing the post secondary class.

13. The computer software implemented method of claim 10, wherein evaluating the student further includes reviewing prior school transcripts.

14. A method of educating a secondary student in a secondary forum located in proximity to a post secondary campus, comprising: or a uniquely constructed combined campus;
assessing academic competence of the secondary student by administering an assessment test;
assigning a class schedule to the secondary student based on the academic competence, the class schedule having a secondary class and a post secondary class;
organizing the secondary forum so that the secondary student attends the secondary class under the secondary forum and the post secondary class on the post secondary campus; and
awarding post secondary credit to the secondary student upon passing the post secondary class.

15. The method of claim 14, wherein assessing academic competence of the secondary student includes reviewing prior school transcripts with parents, administrators' and student present.

16. The method of claim 14, wherein the secondary forum is co-located on the post secondary campus.

17. The method of claim 16, wherein the secondary forum and post secondary campus share resources and facilities.

18. The method of claim 14, wherein the secondary class is scheduled in accordance with the post secondary class.

19. The method of claim 4, further including offering special classes and/or post sessions for the secondary student to adapt to the post secondary class.

20. The method of claim 14, wherein the class schedule is assigned by an administrator of the secondary forum based on the assessment of the secondary student.

21. An integrating secondary and post secondary program which allows a student to receive a secondary diploma and earn post secondary credit, comprising:
means for providing a secondary in proximity to a post secondary campus; and/or a uniquely combined campus;
means for evaluating a student to ascertain academic aptitudes and capabilities;
means for assigning a class schedule to the student based on the evaluation of the student, the class schedule having at least one secondary class and at least one post secondary class; and
means for organizing a secondary forum, wherein the student attends the secondary class in the secondary and attends the post secondary class on the post secondary campus according to the class schedule.

22. The integrating secondary and post secondary program of claim 21, wherein the student earns post secondary credit upon passing the post secondary class.

23. The integrating secondary and post secondary program of claim 21, further including means for administering a post secondary placement exam.

24. The integrating secondary and post secondary program of claim 21, further including means for reviewing prior school transcripts.

25. The integrating secondary and post secondary program of claim 21, wherein the secondary class is scheduled in accordance with the post secondary class.

26. The integrating secondary and post secondary program of claim 21, further including means for offering special classes for the student to adapt to the post secondary class.
